(19) United States
(12) Patent Application Publication
(10) Pub. No.: US 2024/0420393 A1
(43) Pub. Date: Dec. 19, 2024

(54) REAL-TIME AUGMENTATION OF A TARGET FACE

(71) Applicant: Deep Voodoo, LLC, El Segundo, CA (US)

(72) Inventors: Christopher J. Kenny, El Segundo, CA (US); Howard S. Yoo, Irvine, CA (US); Jie Tang, Merion Station, PA (US)

(21) Appl. No.: 18/334,165

(22) Filed: Jun. 13, 2023

(51) Int. Cl. G06T 11/60; G06V 20/40; G06V 40/16

(52) U.S. Cl. CPC G06T 11/60; G06V 20/46; G06V 20/49; G06V 40/161; G06V 40/168; G06V 40/172; G06T 2210/22

(57) ABSTRACT

Real-time augmentation of a target face is disclosed, including: obtaining a set of user facial features corresponding to an input user face in a recorded video frame; using at least the recorded video frame and the set of user facial features to generate a cropped image comprising the input user face; using a target face swap model to encode at least a portion of the cropped image into a plurality of user extrinsic features; using the target face swap model and the plurality of user extrinsic features to generate a representation of a target face; and overlaying the representation of the target face over the recorded video frame.

### BACKGROUND OF THE INVENTION

Due to the substantial computation involved in manipulating a first image of a first face to match the expression of a second face in a second image, this manipulation is typically performed offline. As such, it is difficult to manipulate a target face image to mimic an input user's current face image in a video frame in real-time and have the manipulation be displayed in a manner that does not significantly lag behind the user's current facial expressions and movements. Furthermore, the manipulation of a target face image to match that of an input user's face is further complicated when multiple input user's faces are present within a video frame. It is challenging to manipulate each target user's face image to match the current expression/rotation of a respective corresponding input user's face especially because the input users may rotate or move across video frames.

### BRIEF DESCRIPTION OF THE DRAWINGS

Various embodiments of the invention are disclosed in the following detailed description and the accompanying drawings.

FIG. 1 is a diagram showing an embodiment of a system for performing real-time augmenting of one or more target faces.

FIG. 2 is a diagram showing an example of a face augmentation system in accordance with some embodiments.

FIG. 3 is a flow diagram showing an embodiment of a process for real-time augmentation of a target face.

FIG. 4 is a flow diagram showing an embodiment of a process for real-time augmentation of a plurality of target faces.

FIG. 5 is a diagram showing an example pipeline of generating a composite video frame with representation(s) of target face(s) corresponding to n input user faces that have been detected in an input recorded video frame.

FIG. 6 is a flow diagram showing an example process for detecting input user faces within a recorded video frame in accordance with some embodiments.

FIG. 7 is a flow diagram showing an example process for detecting facial landmarks corresponding to detected input user face(s) within a recorded video frame in accordance with some embodiments.

FIG. 8 is a flow diagram showing an example process for generating a cropped image and set of alignment information corresponding to each input user face within a recorded video frame in accordance with some embodiments.

FIG. 9 is a diagram showing several examples of aligned, cropped images of input user faces that were generated from respective video frames.

FIG. 10 is a flow diagram showing an example process for identifying the input user face(s) within a recorded video frame in accordance with some embodiments.

FIG. 11 is a flow diagram showing an example process for generating a 2D image of a target face corresponding to a detected input user face from a recorded video frame in accordance with some embodiments.

FIG. 12 is a diagram showing examples of a target face and an associated example mask associated with the target face.

FIG. 13 is a flow diagram showing an example process for overlaying a 2D image of a target face over a detected input user face in a recorded video frame.

FIG. 14A is a diagram showing a first example of an original video frame and a corresponding composited video frame.

FIG. 14B is a diagram showing a second example of an original video frame and a corresponding composited video frame.

FIG. 15 is a diagram showing an example pipeline of using predicted face locations to generate a composite video frame with representation(s) of target face(s) corresponding to n input user faces that have been detected in an input recorded video frame.

FIG. 16 is a flow diagram showing an example process of using predicted face locations to generate cropped images of input user faces from a current video frame in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of real-time augmentation of a target face are described herein. A set of user facial features corresponding to an input user's face in a recorded video frame is obtained. In some embodiments, the “input user” is a user whose face is being recorded in a video and the facial expressions/movements of whom are to be mapped to a selected target face. In various embodiments, a “target face” comprises a face for which a model has been pre-generated. For example, the target face may be the likeness of a public figure, a celebrity, or another person/avatar for which a manipulatable machine learning model has been previously generated. In some embodiments, for each video frame in the recording, the faces of distinct input users that appear within the video frame are first detected, and for each detected face of a single input user in a video frame, a corresponding representation of a target face corresponding to that input user is generated and overlaid on that recorded video frame. For an input user's face that is detected in a recorded video frame, facial features comprising a predetermined set of facial landmarks can be determined from the input user's face in that recorded video frame. For example, landmarks include eye corners, mouth corners, eyebrow ends, and nose tip and can be represented as coordinates in 3-dimensional (3D) space. The set of user facial features associated with the input user is used to generate a cropped image comprising the input user's face from the original recorded video frame. In some embodiments, the cropped image of the input user's face from the recorded video frame is generated to include standardized user face dimensions and face alignment. In some embodiments, the cropped image is generated along with a set of transformation information that describes how to transform the cropped image so that the shown input user's face can revert back to how it appears within the recorded video frame. In various embodiments, a target face that is to be manipulated to match the expressions of the input user's face is selected. For example, the target face belongs to a target individual (e.g., a known person, a celebrity, a computer avatar). In various embodiments, a (e.g., machine learning) model of the target face has been previously generated using training data that comprises cropped images of the target face and where such cropped images included the same standardized dimensions and alignment as the cropped image of the input user. This previously generated model of the target face is used to encode at least a portion of the cropped image of the input user face into a plurality of user extrinsic features. In various embodiments, encoding the cropped image of the input user face includes to extract extrinsic features (e.g., extrinsic features are features that are related to facial movement and expressions, as opposed to skin color) (which are represented as vectors) from the cropped image. The target face swap model and the plurality of user extrinsic features are used to generate a representation of the target face. In various embodiments, the extrinsic features of the input user face are translated into corresponding features of the target face. The translated corresponding features of the target face are then combined to output a representation of the target face, which comprises a 2-dimensional (2D) image of the target face that shows the expression of the input user face in the recorded video frame. This representation of the target face is then overlaid over the location of the input user face in the recorded video frame. By processing each detected input user face in each recorded video frame as described herein, the respective representations of target face overlaid consecutive recorded video frames can result in an output video of the target face that mimics the expressions and movements of the input user in the recorded input video. As such, the output, composited video frames show the input user's face having been swapped with that of a corresponding target face.

Embodiments of real-time augmentation of a plurality of target faces are described herein. A first input user face and a second input user face are detected in a recorded video frame. In some embodiments, the first input user face and the second input user face were known in advance of detection. In some embodiments, the first input user face and the second input user face were not known in advance of detection and were instead selected by an operator in the recorded video frame. When two or more input user faces are detected within a recorded video frame and each such input user face is to map to a corresponding target face, there is a need to track the input user faces as they rotate or move within a recorded video so that the expressions of input users can be correctly mapped to their respective target faces. After the first and the second input user faces are detected, a first identifier is associated with the first input user face and a second identifier is associated with the second input user face. In some embodiments, the respective identifier of each input user face is an operator input value. A first mapping is stored between the first identifier and a first target face and a second mapping is stored between the second identifier and a second target face. For example, the selection of a corresponding target face can be made for each input user face or the input user face's associated identifier. Then, a corresponding set of user facial features is separately determined corresponding to each input user face and used to generate the cropped image of the input user face to result in the overlay of the representation of the target face that corresponds to that input user face's identifier in the recorded video frame, as described above. Where the recorded video frame includes two or more input user faces, each such input user face in the recorded video frame is overlaid with a corresponding representation of the respective/mapped-to target user face and where each representation of the respective/mapped-to target user face mimics the expression of the corresponding input user face in that recorded video frame. The effect is that the output video frames show each input user's face having been swapped with that of a corresponding target face.

As will be described in further detail below, when two or more input users are detected in a recorded video frame, the representation of a respective target user face can be processed for each input user face in parallel by leveraging efficient processors (e.g., graphic processing units (GPUs)). Additionally, in some embodiments, alignment information of an input user face from (recent) historical recorded video frames can be used to predict the location of the facial features of a new recorded video frame, which ultimately leads to the faster computation of the representation of the target face that corresponds to the input user face. Such optimizations, among others, reduce the lag between the recording of a video frame and the resulting version of the video frame that is overlaid with representations of target face(s) to result in a system that takes as input a video recording that shows at least one input user face and outputs, in real-time (e.g., with minimal lag), the same video recording only with at least a target face that mimics the expression movements of the input user face and that replaces the input user face in the video recording.

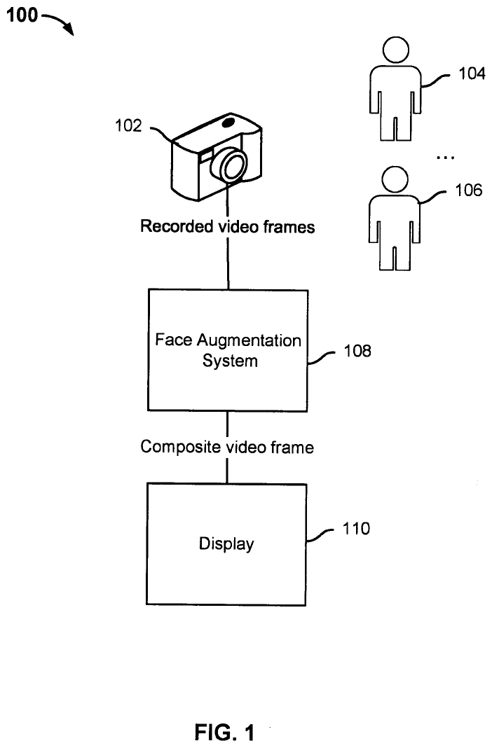

FIG. 1 is a diagram showing an embodiment of a system for performing real-time augmenting of one or more target faces. As shown in FIG. 1, system 100 includes camera 102, input user 104, input user 106, face augmentation system 108, and display 110.

Camera 102 is configured to record a video recording comprising at least one video frame showing the faces of one or more input users. FIG. 1 shows only two input users (104 and 106), but in actual implementation, camera 102 can record a video showing a single input user or any number of input users greater than one. During the video recorded by camera 102, input users 104 and 106 can change their facial expressions, their location, and/or the rotation of their heads. In some embodiments, camera 102 is configured to generate video frames/images at high-definition (e.g., 1080p (1,920 pixels displayed across the screen horizontally and 1,080 pixels down the screen vertically)) or higher resolution.

Face augmentation system 108 is configured to obtain recorded video frames associated with a video recording of input user 104 and/or input user 106 from camera 102. In some embodiments, face augmentation system 108 is configured to receive recorded video frames associated with a video recording as the video recording is in progress. In some embodiments, face augmentation system 108 executes a specially configured driver that is customized to obtain the image data of each video frame directly from camera 102 and store it directly in the memory of one or more GPUs in a manner that bypasses a central processing unit (CPU) of face augmentation system 108. In some embodiments, the GPU(s) of face augmentation system 108 are configured to compute the respective representations of target faces (e.g., manipulated images of target faces such that the target faces match the expression/rotation of the corresponding input user faces) that correspond to the faces of the one or more input users that appear within each video frame in parallel so that the computations can be completed efficiently.

Face augmentation system 108 is configured to first detect input user face(s) that appear within a recorded video frame of a video recording. In some embodiments, prior to the detection, face augmentation system 108 receives a selection associated with the number of input users' faces to detect within each video frame (and ultimately face swap with specified respective target faces). The selection associated with the number of input users' faces to detect within each video frame may indicate a single input user face or any specified number of input user faces. In the event that the face augmentation system 108 receives a selection to detect a single input user face, in various embodiments, face augmentation system 108 is configured to detect the input user face that appears to be the largest (e.g., the input user face that is bounded by the largest bounding box) in a video frame if more than one input user face is present within the video frame. Otherwise, in the event that the face augmentation system 108 receives a selection to detect a specified two or more number of input user faces, in various embodiments, face augmentation system 108 is configured to detect the largest specified number of input user faces (e.g., the input user faces that are bounded by the largest bounding boxes) in a video frame if more than the specified number of input user faces are present within the video frame.

Regardless of how many input user faces are detected by face augmentation system 108 within the video frame, face augmentation system 108 is configured to separately process each input user face for the video frame to perform a face swap (e.g., generate a representation of the target face that corresponds to the identifier of that input user face). In some embodiments, where there are more than one detected input user face in a video frame, face augmentation system 108 is configured to process, at least in parallel, the two or more input user faces in the video frame to generate the respective representations of the target faces. For each input user face that is detected in a video frame, face augmentation system 108 is configured to determine the facial features of the input user face in the video frame. Examples of the facial features include the coordinates in 3-dimensional (3D) space of the facial landmarks such as eye corners, mouth corners, nose tip, nose bridge, and eyebrow ends. After the facial features are determined for the input user face in the video frame, face augmentation system 108 is configured to determine alignment information from the facial features and generate a cropped image of the input user face based on the alignment information. In some embodiments, the “alignment information” describes the position (e.g., rotation and translation relative to a given center) and/or scale of the input user's head in 3D space. Then, the input user face in the video frame is oriented to a standardized orientation (e.g., upright) and at least some of the facial features (e.g., eyes) are aligned with a specified position and scaled to a specified dimension within the cropped image, which is generated to have specified/standardized dimensions. As such, cropped images of the input user faces (associated with the same or different input users) that are derived from different video frames will have standardized dimensions and each will show a face in the same orientation with facial features (e.g., eyes) located within the same location within the cropped image.

Face augmentation system 108 is configured to determine a user face identifier (ID) to be associated with the cropped image of each detected input user face of the video frame. In various embodiments, face augmentation system 108 is configured to prompt the operator to specify whether input user faces for which user face IDs are to be assigned are “known” in advance to the system. An input user face that is “known” to face augmentation system 108 is one for which a corresponding signature (e.g., a mathematical embedding that has been previously generated based on known images of that user) is stored/available to face augmentation system 108. In contrast, an input user that is “unknown” to face augmentation system 108 is one for which a corresponding signature (e.g., a mathematical embedding that has been generated based on known images of the input user) is not stored/available to face augmentation system 108. In the event that face augmentation system 108 receives an indication that the input user(s) are known in advance, face augmentation system 108 is configured to identify (e.g., assign user face IDs to) the cropped image(s) of the input user(s) in a video frame based on the stored signatures corresponding to the known input users. Otherwise, in the event that face augmentation system 108 receives an indication that the input user(s) are not known in advance, in some embodiments, face augmentation system 108 is configured to present the cropped image(s) of the detected input user face(s) at a user interface, and then receive operator selection of which such detected input user faces are associated with which user face IDs and are therefore to proceed to further processing (e.g., the manipulation of corresponding target faces). Face augmentation system 108 then stores the cropped image corresponding to each selected input user face as a reference image to use to detect the same/similar input user face in a subsequently received video frame from the same video recording. Each user face ID is mapped to a target face ID. In some embodiments, the mapping between each user face ID and a corresponding target face ID can be determined by the operator at a user interface of face augmentation system 108 or stored in advance. Each target face ID that is available to map to a user face ID is one for which a corresponding target face swap model has been previously generated.

Face augmentation system 108 is configured to generate a representation of a target face that corresponds to each detected input user face of the video frame. In various embodiments, face augmentation system 108 is configured to determine the face ID corresponding to each input user face. Then, face augmentation system 108 is configured to determine the target face ID to which that face ID maps and then retrieves a previously generated target face swap model associated with that target face ID. In various embodiments, a target face swap model comprises a model that is generated based on a number of cropped images of a target individual's face and where each cropped image has been subjected to the same alignment process that was used to obtain the input user face's cropped image. The retrieved target face swap model takes in the cropped image of an input user face and then outputs a representation of the target face that matches the input user face in the cropped image. Specifically, in some embodiments, the output representation of the target face comprises a 2D image of the target face that mimics the expression and the orientation of the input user face that is shown in the cropped image, as will be described in further detail below. In some embodiments, the 2D image comprises an RGB with an alpha channel mask. The alpha channel mask describes which portion of the 2D image of the manipulated target face should be transparent and to which degree.

For example, this 2D image of the target face with the application of the mask includes only the target face but excludes hair and body. Face augmentation system 108 is then configured to modify/transform the representation of the target face based on the alignment information (e.g., the rotation, translation, and scale) that was previously used to determine the cropped image of the input user face. Modifying/transforming the representation of the target face based on the alignment information will orient/scale the target face in a manner that matches the orientation/scale of the input user face in the video frame. Face augmentation system 108 is configured to composite the modified representation of the target face with the original video frame. Compositing the modified representation of the target face with the original video frame comprises overlaying the modified representation of the target face over the location corresponding to the respective input user face within the original video frame. Face augmentation system 108 is configured to output the composite original video frame with the modified representation of the target face to display 110, where the composite video frame is presented. Display 110 (e.g., a monitor) comprises a device with a screen at which a video and other media can be presented.

While the above pipeline describes the processing involved in generating a representation of the target face corresponding to each detected input user face in a single video frame, in some embodiments, the process is repeated per each subsequent video frame of the video recording.

In some embodiments, face augmentation system 108 is configured to speed up the processing of a current video frame in a video recording by predicting/generating the appropriate cropped image corresponding to each input user face in the current video frame using recent historical alignment information from recently processed video frames of the same video recording. This type of sped up processing is sometimes referred to as “predictive.” As will be described in further detail below, “predictive” processing is faster than the pipeline described above, that generates a cropped image for each detected input user face in a video frame using the detected facial features that were determined for that video frame because “predictive” processing does not need to wait for the facial features to be determined for that video frame. Instead, at least in parallel to the facial features being determined for an input user face in the current video frame, the predictive pipeline generates a cropped image of that input user face from the current video frame using a predicted trajectory of the input user face as determined from historical alignment information that has been determined for that input user face as it had appeared in one or more recent, previously processed video frames.

According to various embodiments described herein, a video recording is recorded at camera 102, each video frame thereof is processed in real-time by face augmentation system 108, and the resulting composited video frames, which simulate the desired face swaps of the input user faces with respective target faces, are output to display 110. Due to the efficient processing pipeline(s) of the video frames that leverage the parallel computation of GPUs and in some embodiments, predictions of input user face trajectories based on recent historical video frames, the latency between the recording of a video frame by camera 102 and the displaying of the composite version of that same video frame at display 110 is minimized. This latency, which is sometimes referred to as “glass-to-glass latency,” can be reduced to only 50-75 milliseconds, which is not significantly perceptible to a viewer. A low glass-to-glass latency will provide the effect that the simulated face swapping between input user faces and selected target faces are occurring in real-time.

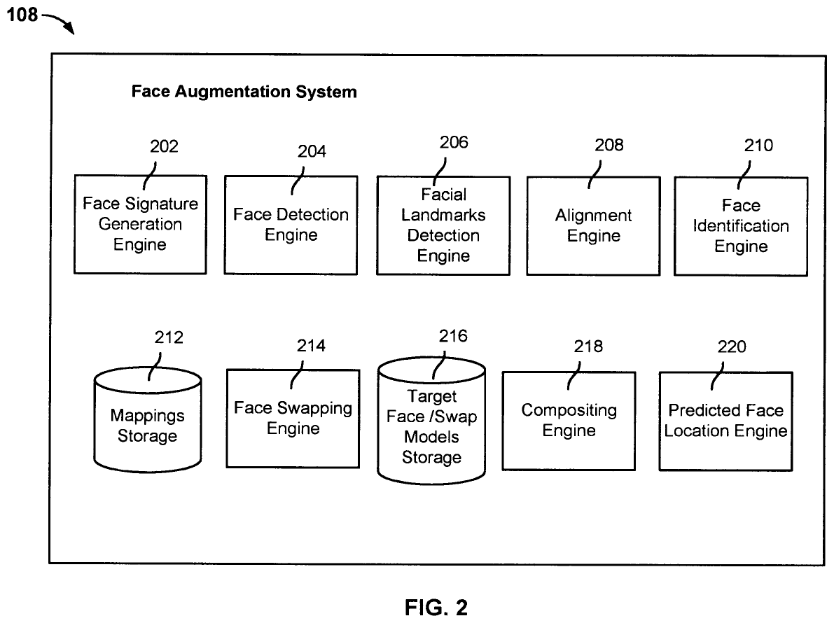

FIG. 2 is a diagram showing an example of a face augmentation system in accordance with some embodiments. In the example of FIG. 2, the face augmentation system comprises face signature generation engine 202, face detection engine 204, facial landmarks detection engine 206, alignment engine 208, face identification engine 210, mappings storage 212, face swapping engine 214, target face swap models storage 216, compositing engine 218, and predicted face location engine 220. Each of face signature generation engine 202, face detection engine 204, facial landmarks detection engine 206, alignment engine 208, face identification engine 210, mappings storage 212, face swapping engine 214, target face swap models storage 216, compositing engine 218, and predicted face location engine 220 may be implemented using hardware (e.g., GPUs) and/or software.

Face signature generation engine 202 is configured to generate a unique signature corresponding to a given face based on images of the given face. For example, in the pipeline of swapping a target face for an input user face, the input user face is to be first identified and that input user identifier is to be used to determine a corresponding target face. In some embodiments, where the input user face for which such a face swap is to be performed is known in advance, the input user face can be identified based on prepared/stored signatures. In various embodiments, a “signature” (which is also sometimes referred to as an “embedding”) comprises a set of vectors (e.g., 512 vectors) that is generated by a machine learning model (e.g., a neural network) that is trained to output a vector representation of a face based on (e.g., 10-20) images of that face as shown in different orientations. In some embodiments, each generated facial signature is associated (e.g., by an operator) with a face ID. For example, the face ID is a human-readable name. In some embodiments, the machine learning model that is configured to generate a signature corresponding to a face is trained on face images that have been aligned in the same way that the video frames with the input user faces will be aligned. As will be described in further detail, when video frames of a (e.g., ongoing) video frame are being processed in real-time, an input user face in a video frame can be identified by face identification engine 210 generating a signature from an aligned/cropped image of that input user face and then comparing that signature to stored signatures to determine whether a match can be determined. If a face signature match can be determined by face identification engine 210, then the input user face is assigned the face ID that has been associated with the stored, matching face signature.

Face detection engine 204 is configured to detect input user face(s) within each video frame of a video recording. In some embodiments, the recording of the video could be completed. In some embodiments, the recording of the video could be in-progress. In some embodiments, face detection engine 204 is configured to execute a machine learning model (e.g., a neural network) that has been trained to output bounding boxes (or other polygons) around each input user face (excluding bodies) that is recognized within an input video frame. In some embodiments, face detection engine 204 has been configured to detect up to a specified number of input user faces. For example, it is only desired to perform face swaps for a single input user or two or more specified number of input user faces (and not for additional input user faces that may appear within a video frame) and so face detection engine 204 is configured to draw bounding boxes (or other polygons) around the largest recognized input user faces up to the specified number of faces (even if additional input user faces are present within the video frame). In various embodiments, face detection engine 204 is configured to output the bounding box(es) around the input user face(s) as well as the video frame to facial landmarks detection engine 206 for further processing.

Facial landmarks detection engine 206 is configured to detect the locations (e.g., coordinates in 3D space) of facial features within the bounding box(es) around input user face(s) that have been determined by face detection engine 204 in each video frame. In some embodiments, facial landmarks detection engine 206 is configured to execute a machine learning model (e.g., a neural network) that has been trained to output the locations of facial features (e.g., facial landmarks) within the bounding box around each input user face within a video frame. Examples of facial landmarks include eye corners, mouth corners, eyebrow ends, and nose tip and can be represented as coordinates in 3-dimensional space. In various embodiments, face detection engine 204 is configured to output the bounding box(es) around the input user face(s) to facial landmarks detection engine 206 for further processing. In various embodiments, facial landmarks detection engine 206 is configured to output the 3D coordinates of facial features of each input user face as well as the video frame to alignment engine 208 for further processing.

Alignment engine 208 is configured to generate a cropped image that includes each input user face that was detected in each video frame based on facial features corresponding to that input user face from facial landmarks detection engine 206. In various embodiments, the cropped image of each input user face comprises a portion of the original video frame and shows the input user face after it was scaled, rotated, and/translated from its appearance in the original video frame to conform to a standardized format. For example, each input user face in a cropped image has eyes that are aligned in accordance with designated locations/width on the cropped image. Furthermore, in addition to the cropped image of each input user face, alignment engine 208 is further configured to generate a set of alignment information corresponding to the cropped image of each input user face, where the alignment information describes the rotation, translation, and/or scaling that was determined to transform the input user face of the video frame into the version that is shown in the cropped image. In some embodiments, each set of alignment information is represented by a transformation matrix that describes the corresponding scaling, rotation, and/or translation of how the input user face that appears in the video frame was transformed to result in the version that is shown in the cropped image. As will be described below, the set of alignment information that is associated with a cropped image of an input user face can be used to transform a target face image that corresponds to the input user face so that the transformed representation of the target face can be appropriately scaled, rotated, and translated in relation to the rest of the video frame before it is composited/overlaid on the video frame, as will be described in further detail below. In various embodiments, alignment engine 208 is configured to output the cropped image and a corresponding set of alignment information of each input user face as well as the video frame to face identification engine 210 for further processing.

Face identification engine 210 is configured to determine a corresponding face ID for each input user for which a cropped image was received from alignment engine 208. In some embodiments, if stored signatures (e.g., that was generated in advance by face signature generation engine 202) of known faces are available, then face identification engine 210 is configured to generate a signature from each cropped image of an input user face and then compare that signature to each stored signature to determine whether a match can be found. In the event that a match can be found, then the cropped image and the input user face shown within would be assigned the face ID that is associated with the matching stored signature. Otherwise, if no stored signatures are found to match the signature(s) of the cropped images of the input user face(s), then face identification engine 210 is configured to present the cropped image(s) at a user interface and prompt an operator to provide a respective face ID for each cropped image. Face identification engine 210 is configured to store each operator submitted face ID corresponding to each cropped image and also store the cropped image of each separate input user face as a reference image corresponding face ID. In some embodiments, upon receiving cropped image(s) corresponding to input user face(s) from the same video recording, face identification engine 210 can compare the cropped images to the reference images to determine if matches exist. Where a match between a cropped image and a stored reference image exists, face identification engine 210 can assign the input user face of the cropped image with the face ID that is associated with the matching stored reference image. In various embodiments, face identification engine 210 is configured to output each cropped image, a corresponding set of alignment information, and the face ID of each input user to face swapping engine 214 for further processing.

Face swapping engine 214 is configured to generate a representation of a target face corresponding to each cropped image of an input user face that it had received from face identification engine 210. Face swapping engine 214 is configured to use the face ID corresponding to an input user face cropped image to look up a corresponding target face ID from the face ID to target face ID mappings that are stored at mappings storage 212. Then, face swapping engine 214 is configured to use the looked-up target face ID corresponding to the input user face cropped image to locate a previously generated target face swap model that is associated with that target face ID from target face swap models storage 216. In various embodiments, each target face swap model that is stored at target face swap models storage 216 was trained based on images showing various orientations/angles of a corresponding target face. For example, target faces may include the faces of celebrities, public figures, or other individuals for which it may be desirable to have facial expressions/movements of the individuals be augmented/swapped with that of an input user. In some embodiments, each image on which a target face swap model was trained was also a cropped image that was aligned according to the standardized format associated with the cropped images of the input user faces that were generated by alignment engine 208. If there are two or more input user faces for which cropped images and face IDs are received at face swapping engine 214, then face swapping engine 214 would retrieve the separate target face swap models corresponding to respective ones of the input user faces to separately generate different representations of the target faces corresponding to the input user faces. In some embodiments, each target face swap model stored at target face swap models storage 216 comprises a separate neural network or other machine learning model. In some embodiments, face swapping engine 214 is configured to execute each target face swap model to output a 2D image that shows the target face mimicking the expression/orientation of the corresponding input user face as shown in the input cropped image. As will be described in further detail below, specifically, in executing a target face swap model, face swapping engine 214 is configured to encode an input cropped image of an input user face into a set of vectors (e.g., 512 vectors) that mathematically represent various extrinsic features (e.g., aspects related to facial expressions that can be transferred from one face to another, unlike intrinsic features like eye color and skin color) of the input user face. Then, the target face swap model is configured to decode that set of vectors by translating a mathematical model of the target face using the set of vectors to ultimately generate a representation (e.g., a 2D image) of the target face shown to have the same expressions and orientation as those of the corresponding input user face. In some embodiments, the 2D image of the target face that is output by a target face swap model comprises an RGB image with an alpha channel that describes the outline of the target face via a mask that indicates where the output image is transparent (e.g., outside of the boundary of the target face) and where the output image is not transparent or semi-transparent (e.g., within the boundary of the target face, the image is not transparent and the edges of the target face could be semi-transparent). Face swapping engine 214 is configured to send the respective representation (e.g., a 2D image) of the target face corresponding to each input user face that was detected from the video frame along with the respective sets of alignment information and the original video frame to compositing engine 218.

Compositing engine 218 is configured to modify the representation (e.g., a 2D image) of each target face based on the corresponding set of alignment information associated with the input user face that was received from face swapping engine 214 and then overlay the modified representation over the input user face in the original video frame.

Modifying/transforming the representation/2D image of each target face by the set of alignment information associated with the input user face will cause the target face image to have the same scaling/rotation/translation as the corresponding input user face in the original video frame. Where there are multiple input user faces/representations of target faces per one video frame, the resulting composited video frame will include for each input user face, a corresponding overlay of a target face image in which the target face mimics the facial expression/orientation of the corresponding detected input user face. Because each target face image includes only the target face without the target individual's hair or body, the modified representation of each target face once overlaid on the video frame will inherit the original hair and body of the input user, thereby resulting in only the desired swap of faces.

Predicted face location engine 220 is configured to skip the face detection output by face detection engine 204, facial landmarks detection output by facial landmarks detection engine 206, and alignment information by alignment engine 208 with respect to a current video frame by generating a cropped image from a current video frame based on the historical face bounding boxes, facial landmark coordinates in 3D space, and/or alignment information that was determined for recent historical video frames from the same video recording. Especially when the frame rate that is used by the camera that records the video frames is high (e.g., 60 frames per second (fps) or higher), it is expected that an input user face will not significantly change between adjacent video frames. As such, in some embodiments, predicted face location engine 220 executes a machine learning model that can use the historical face bounding boxes, facial landmark coordinates, and alignment information of cropped images that were determined by face detection engine 204, facial landmarks detection engine 206, and alignment engine 208 for the last predetermined number of historical video frames to determine a face trajectory and use this trajectory to output/predict the bounding box, facial landmark coordinates, and/or alignment information of the input user face in the current video frame. This predicted information is then used to generate a cropped image of the input user face directly from the current video frame, which is then output to face identification engine 210 and to proceed through the rest of the pipeline for producing a composite video frame, as described above. In some embodiments, the current video frame can still be processed by face detection engine 204, facial landmarks detection engine 206, and alignment engine 208 and the bounding box, facial landmark coordinates, and alignment information of the input user face in the current video frame as determined by the engines can be used to evaluate the predicted cropped image for errors. Any errors can be used to retrain the model associated with predicted face location engine 220 to make more accurate future predictions/cropped images from subsequent current video frames without waiting on the outputs from face detection engine 204, facial landmarks detection engine 206, and alignment engine 208 with respect to those video frames.

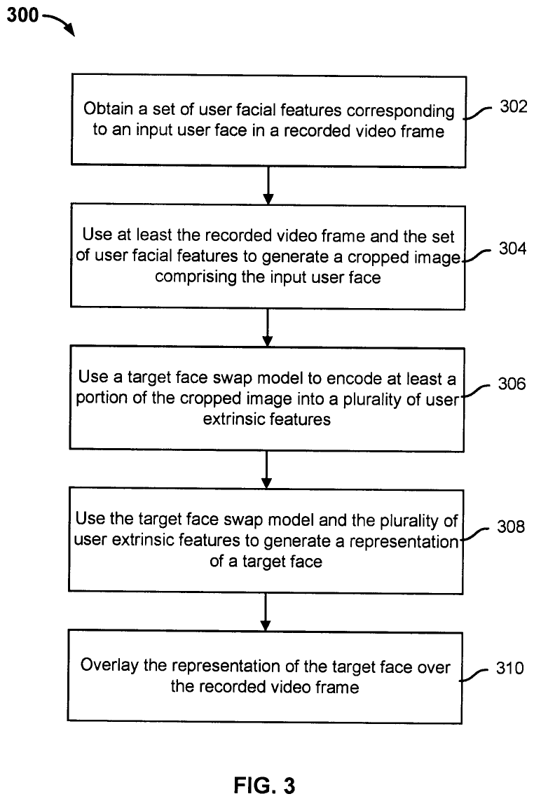

FIG. 3 is a flow diagram showing an embodiment of a process for real-time augmentation of a target face. In some embodiments, process 300 is implemented by face augmentation system 108 of system 100 of FIG. 1.

At 302, a set of user facial features corresponding to an input user face in a recorded video frame is obtained. After the input user face is detected within a recorded video frame, a set of facial landmarks is determined from the input user face within the video frame. In some embodiments, the detected bounding box around the input user face within the video frame is input into a machine learning model that is trained to output the coordinates in 3D space of facial landmarks on the input user face.

At 304, at least the recorded video frame and the set of user facial features are used to generate a cropped image comprising the input user face. The coordinates in 3D space that describe the locations of the facial landmarks on the input user face within the video frame are used to scale, rotate, and/or translate the input user face within the video frame to generate a cropped image (a portion of the video frame) that includes the input user face that conforms to a normalized/standardized orientation, alignment, size, and/or dimensions.

At 306, a target face swap model is used to encode at least a portion of the cropped image into a plurality of user extrinsic features. A target face for which a representation thereof is to be augmented to match the expressions and/or orientation of the input user face is determined. In some embodiments, the target face that corresponds to the input user face is determined based on a face ID that is determined for the input user face based at least in part on the cropped image. A previously generated target face swap model that corresponds to this target face is determined. The cropped image of the input user face is input into the target face swap model, which then encodes the cropped image into a set of vectors that mathematically describe the various extrinsic features of the input user face as shown in the cropped image.

At 308, the target face swap model and the plurality of user extrinsic features are used to generate a representation of a target face. The set of vectors that was encoded from the cropped image is used by the target face swap model to transform a previously generated mathematical model of the target face to result in a 2D image of the target face that includes extrinsic features (e.g., expressions, orientation) that match those of the input user face. In some embodiments, the 2D image also includes a mask that describes the target face as being opaque with soft edges in an otherwise transparent background.

At 310, the representation of the target face is overlaid over the recorded video frame. The 2D image of the target face is overlaid over the recorded video frame to result in a composite video frame that shows the target face with expressions and an orientation that matches those of the input user face. In some embodiments, prior to being overlaid over the original video frame, the 2D image of the target face is first transformed based on the alignment information that was used to scale, orient, and/or translate the input user face in the video frame to obtain the cropped image of the input user face so that the transformed 2D image of the target face would match the scale, orientation, and/or translation of the input user face that is to be covered by the overlaid 2D image of the target face.

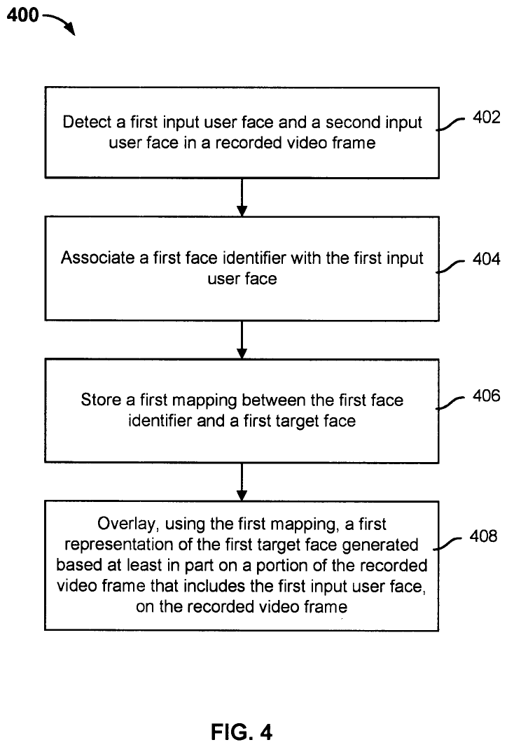

FIG. 4 is a flow diagram showing an embodiment of a process for real-time augmentation of a plurality of target faces. In some embodiments, process 400 is implemented by face augmentation system 108 of system 100 of FIG. 1.

At 402, a first input user face and a second input user face are detected in a recorded video frame. At least two input user faces are detected within the same recorded video frame.

At 404, a first face identifier is associated with the first input user face. A corresponding face identifier is associated with each of at least two detected input user faces in the video frame.

At 406, a first mapping between the first face identifier and a first target face is stored. A respective face ID is assigned to each distinct input user face and this face identifier is also mapped to a corresponding target face ID so that the same input user face, across multiple video frames, can be consistently mapped to the same target face to be augmented to match the extrinsic features of the input user face.

At 408, a first representation of the first target face generated based at least in part on a portion of the recorded video frame that includes the first input user face is overlaid on the recorded video frame using the first mapping. A previously generated target face swap model that corresponds to each target face is configured to take as input, a cropped image of the corresponding input user face from the video frame, and output a 2D image of the target face that includes extrinsic features (e.g., expressions, orientation) that match those of the input user face. This 2D image of the target face is then laid over the corresponding input user face on the video frame so as to replace the input user face with a version of the target face that has the same expressions/orientations, as described above in process 300, for example.

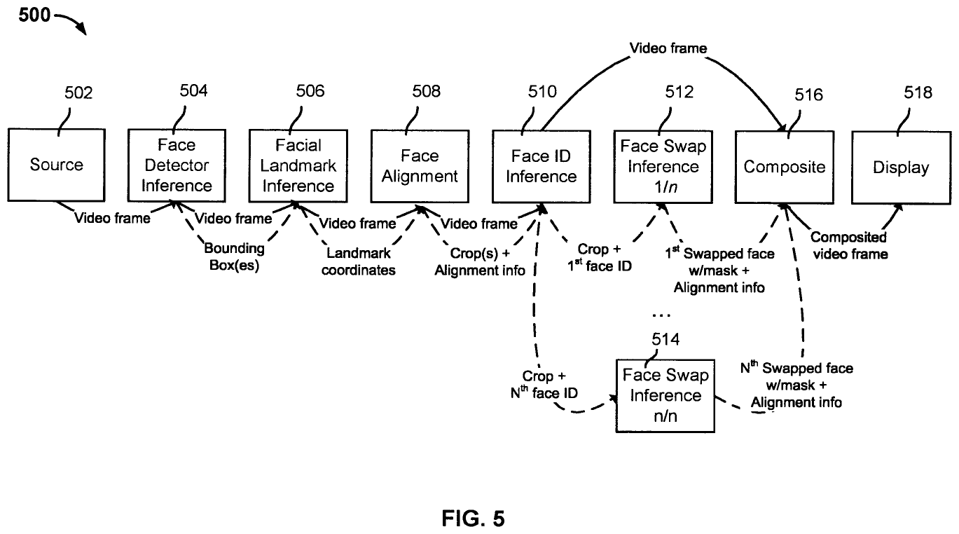

FIG. 5 is a diagram showing an example pipeline of generating a composite video frame with representation(s) of target face(s) corresponding to n input user faces that have been detected in an input recorded video frame. Source 502 of face swap pipeline 500 records a video frame in the process of making a video recording. The source can be a camera or a storage at which a video frame is stored. For example, one or more input users are standing in front of and also facing the camera. The recorded video frame is output to face detector inference 504. Face detector inference 504 is running a first machine learning model (e.g., neural network) that is configured to draw bounding boxes around detected input user faces within the video frame. In some embodiments, face detector inference 504 is configured to receive an operator submitted parameter specifying the maximum number of faces (n) to detect and so face detector inference 504 is configured to draw bounding boxes around as many as n largest number of input user faces within the video frame. The bounding boxes (e.g., as described by the coordinates/vectors in 3D space that represent the four corners/edges of each bounding box) of the detected up to n number of input user faces along with the video frame are output from face detector inference 504 to facial landmark inference 506. Facial landmark inference 506 is configured to run a second machine learning model (e.g., neural network) to detect the coordinates in 3D space of a set of facial landmarks of each input user face within each bounding box relative to the video frame. Facial landmark inference 506 is configured to output the facial landmark coordinates of each input user face and the video frame to face alignment 508. Face alignment 508 is configured to generate a cropped image comprising each input user face from the video frame and where the input user face that is shown in the cropped image is oriented/aligned/scaled according to normalized/standardized parameters. Face alignment 508 is also configured to generate a corresponding set of alignment information for each cropped image, where the set of alignment information describes the scaling, rotation, and/or translation that was performed on the input user face as shown in the video frame to result in the version that was shown in the cropped image. Face alignment 508 is configured to output the cropped image and set of alignment information corresponding to each input user face to face ID inference 510. Face ID inference 510 is configured to run a third machine learning model (e.g., neural network) for determining a face ID corresponding to each cropped image. As will be described in further detail below, face ID inference 510 is configured to determine a face ID corresponding to the input user face of each cropped image differently depending on whether or not the input user face was a known face prior to the video frame being processed in the pipeline and for which a facial signature was previously generated. After a face ID is determined for each cropped image, face ID inference 510 can determine a target face ID that corresponds to each face ID based on stopped mappings and then output each cropped image and its corresponding face ID to the respective target face swap model that is associated with the target face ID that corresponds to the face ID. In the example of FIG. 5, there are n number of input user faces and therefore n number of cropped images and each of which will be output to a respective, previously generated target face swap model, where each (e.g., face swap inference 1/n 512 through face swap inference n/n 514) is configured to run a respective machine learning model that is configured to output a respective 2D representation/image of the associated target face (the “swapped image”) that matches the extrinsic features (e.g., expressions, movement) of the respective input user face as shown in the corresponding cropped image. Each of the n number of 2D representations/images of the target faces (with masks) will be output by the respective face swap inference to composite 516. Composite 516 is configured to transform each n 2D representation/image of a target face by the respective set of alignment information so that the 2D representation/image of the target face will inherit the orientation/scale of the corresponding input user face as it was shown in the video frame prior to being aligned for the cropped image. Composite 516 is configured to then composite/overlay the transformed n 2D representations/images of target faces on the original video frame (that was received from face ID inference 510). Composite 516 is configured to output the composite video frame to display 518, which will then output the composite video frame with the overlaid 2D images of target faces at a screen or other type of user interface. Processing pipeline 500 as shown in FIG. 5 can be repeated for each of at least some video frames in a video recording. As shown in processing pipeline 500, for each video frame that is input into the pipeline, a corresponding composite video frame is output.

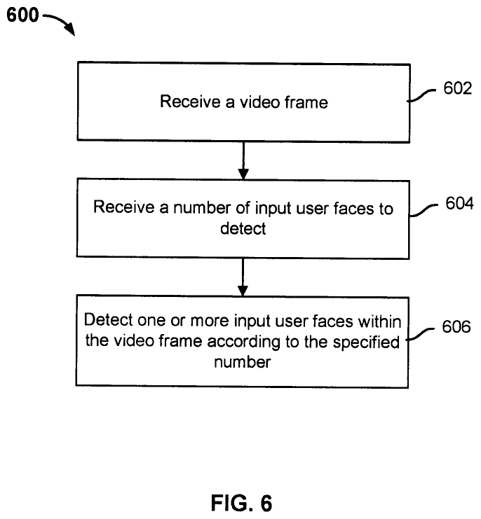

FIG. 6 is a flow diagram showing an example process for detecting input user faces within a recorded video frame in accordance with some embodiments. In some embodiments, process 600 is implemented at face augmentation server 108 of FIG. 1. In some embodiments, face detector inference 504 of pipeline 500 of FIG. 5 may be implemented using process 600.

At 602, a video frame is received.

At 604, a number of input user faces to detect is received. Because more input user faces can be detected within the video frame than is desired, the operator can constrain the maximum number of input user faces to detect for further processing in the face swap pipeline. For example, only the faces of the foreground actors and not those of the background actors in the video frame are desired to be swapped with target faces in the resulting composite video frame.

At 606, one or more input user faces are detected within the video frame according to the specified number. A machine learning model is run to detect bounding boxes around the largest specified number of input user faces within the video frame. For example, if the specified number were two, then the largest two bounding boxes that are drawn around the input user faces within the video frame are used for further processing in the face swap pipeline.

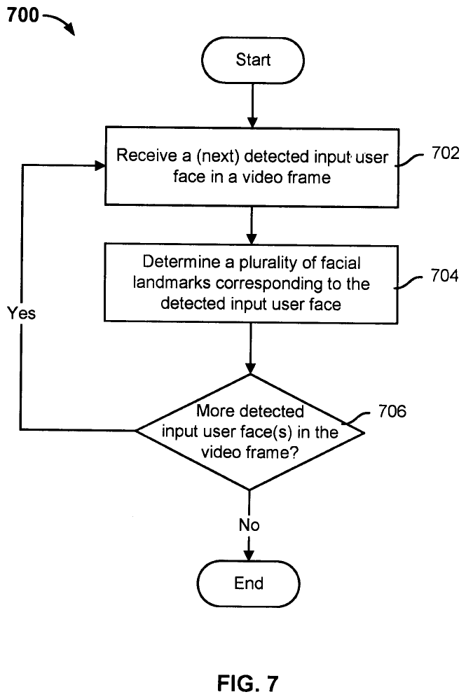

FIG. 7 is a flow diagram showing an example process for detecting facial landmarks corresponding to detected input user face(s) within a recorded video frame in accordance with some embodiments. In some embodiments, process 700 is implemented at face augmentation server 108 of FIG. 1. In some embodiments, facial landmark inference 506 of pipeline 500 of FIG. 5 may be implemented using process 700.

At 702, a (next) detected input user face in a video frame is received. In some embodiments, the detection of each input user face within a video frame comprises the bounding box around that input user face. For example, the bounding box can be represented as the four coordinates in 3D space corresponding to the four corners of the box.

At 704, a plurality of facial landmarks is determined corresponding to the detected input user face. The 3D coordinates corresponding to a set of predetermined facial landmarks are determined on each input user face within the bounding box around that face in the video frame.

At 706, whether there is at least one more detected input user face in the video frame is determined. In the event that there is at least one more detected input user face in the video frame, control is returned to 702. Otherwise, in the event that there are no more detected input user faces in the video frame, process 700 ends. While process 700 suggests that the facial landmarks can be detected serially for each input user face, in actual implementation, facial landmarks can be detected at least in parallel for two or more input user faces based on their respective bounding boxes.

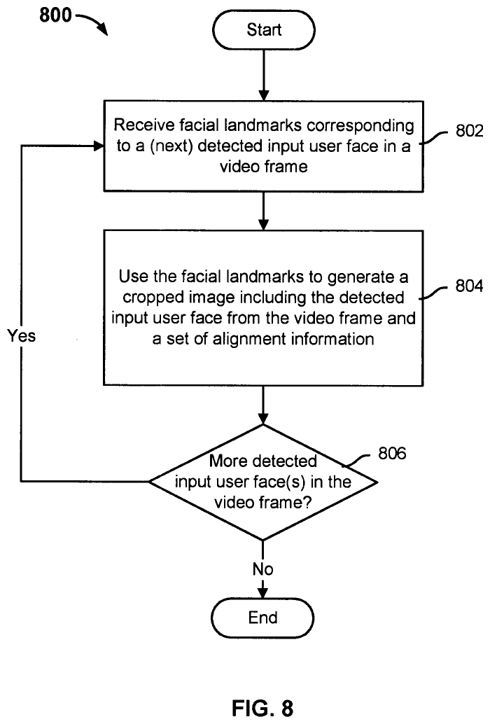

FIG. 8 is a flow diagram showing an example process for generating a cropped image and set of alignment information corresponding to each input user face within a recorded video frame in accordance with some embodiments. In some embodiments, process 800 is implemented at face augmentation server 108 of FIG. 1. In some embodiments, facial landmark inference 506 of pipeline 500 of FIG. 5 may be implemented using process 800.

At 802, facial landmarks corresponding to a (next) detected input user face in a video frame are received.

At 804, the facial landmarks are used to generate a cropped image including the detected input user face from the video frame and a set of alignment information. In some embodiments, the facial landmarks are used to compute a 3D head position of an input user face. This 3D head position is used to detect the translation, rotation, and scale of the input user face in 3D coordinates. The translation, rotation, and scale of the input user face is then used to align the input user face into a crop of the original video frame so as to generate a cropped image of the input user face in which the size of the input user face is aligned with a standardized size and also, the facial landmarks of the input user face are aligned with standardized facial landmark locations within the cropped image. Furthermore, the cropped image is of standardized dimensions (e.g., length and width). The scaling, translation, and/or rotation that were performed on the version of the input user face that was shown in the video frame to generate the version that is shown in the corresponding input user face are collectively referred to as the “set of alignment information” associated with the cropped image. Intuitively speaking, the cropped images of the same input user face that are generated from a series of video frames (even as the input user is moving around within the video frames) would show the center of gravity of this input user's head remaining stable within the cropped images.

At 806, whether there is at least one more detected input user face in the video frame is determined. In the event that there is at least one more detected input user face in the video frame, control is returned to 802. Otherwise, in the event that there are no more detected input user faces in the video frame, process 800 ends. While process 800 suggests that a cropped image can be generated serially for each input user face, in actual implementation, cropped images can be generated at least in parallel for two or more input user faces based on their respective facial landmarks.

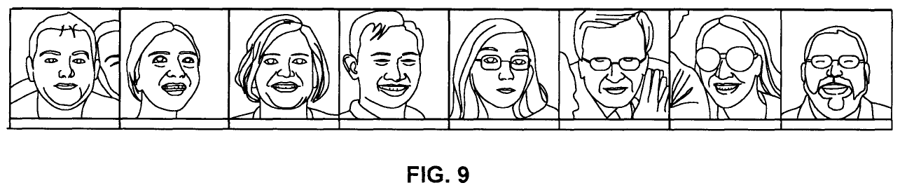

FIG. 9 is a diagram showing several examples of aligned, cropped images of input user faces that were generated from respective video frames. FIG. 9 shows eight example cropped images that were each generated from respective video frames based on the user facial features that were determined for the input user faces. For example, each cropped image of FIG. 9 was generated using a process such as process 800 of FIG. 8. As shown in FIG. 9, each cropped image shows a respective input user face at the same alignment within the frame of the cropped image. For example, the eyes of the input user faces across all the example cropped images are at approximately the same locations within the cropped images. Furthermore, the sizes of the input user faces across all the example cropped images are substantially similar/standardized.

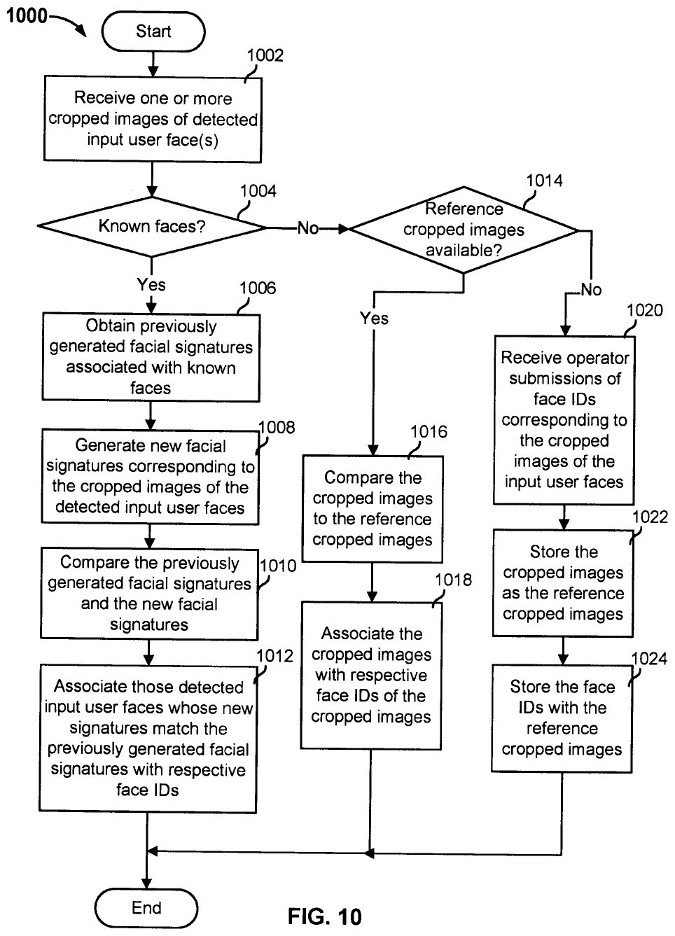

FIG. 10 is a flow diagram showing an example process for identifying the input user face(s) within a recorded video frame in accordance with some embodiments. In some embodiments, process 1000 is implemented at face augmentation server 108 of FIG. 1. In some embodiments, face ID inference 510 of pipeline 500 of FIG. 5 may be implemented using process 1000.

At 1002, one or more cropped images of detected input user face(s) are received.

At 1004, whether prepared facial signatures of known faces are available is determined. In the event that prepared facial signatures of known faces are available, control is transferred to 1006. Otherwise, in the event that prepared facial signatures of known faces are not available, control is transferred to 1014. In some instances, certain input users who are to appear within the video recording are known in advance and as such, the facial signatures of such input users can be prepared in advance so that these users' faces can be later programmatically identified in the face swap processing pipeline. As described above, a facial signature can be generated for an input user based on inputting images of the input user's face (e.g., at different angles, ideally) into an identification network to get a resulting value that represents a unique facial signature for that input user. For example, the facial signature can be a set of 512 vectors. In some embodiments, each known face is assigned a corresponding face ID (e.g., a human readable value).

At 1006, previously generated facial signatures associated with known faces are obtained. The facial signatures of known input user faces that are prepared in advance can be retrieved during the face swap processing pipeline to programmatically identify those detected input user faces within a video frame that are actually known faces.

At 1008, new facial signatures corresponding to the cropped images of the detected input user faces are generated. The cropped image of each detected input user face can be input into the same identification network that was used to generate the facial signatures of the known faces to obtain a new facial signature corresponding to each detected input user face.

At 1010, the previously generated facial signatures are compared to the new facial signatures. The previously generated facial signatures corresponding to known faces are compared to the new facial signatures that have been generated for the detected input user faces to determine whether there are any matches. For example, a similarity value can be compared between each previously generated facial signature and each new facial signature and the similarity value can be compared to a threshold. If the similarity value is greater than the threshold, then the detected input user face of the matching new facial signature is determined to be the same face as the known face.

At 1012, those detected input user faces whose new signatures match the previously generated facial signatures are associated with respective face IDs. Each detected input user face whose facial signature matches the stored facial signature of a known face is assigned the face ID that is associated with the known face.

At 1014, whether reference cropped images are available is determined. In the event that the reference cropped images are available, control is transferred to 1016. Otherwise, in the event that the reference cropped images are not available, control is transferred to 1020. If facial signatures corresponding to the known faces are not available (e.g., prepared in advance), then stored reference images (e.g., cropped images of input user faces that have been generated from previous video frames of the video recording and labeled with corresponding face IDs by an operator) can be compared to the cropped images of the detected input user faces of the current video frame.

At 1016, the cropped images are compared to the reference cropped images. The stored reference images that were previously labeled with face IDs are compared to the cropped images that have been generated for the detected input user faces to determine whether there are any matches. For example, a similarity value can be compared between each reference image and each cropped image and the similarity value can be compared to a threshold. If the similarity value is greater than the threshold, then the detected input user face of the matching cropped image is determined to be assigned the face ID that was associated with the matching reference image.

At 1018, the cropped images are associated with respective face IDs of the cropped images.

At 1020, operator submissions of face IDs corresponding to the cropped images of the input user faces are received. Where reference images are not available, a prompt can be presented at a user interface to invite an operator to label each cropped image with a corresponding face ID.

At 1022, the cropped images are stored as the reference cropped images. After the cropped images are labeled with respective face IDs, the cropped images are stored as reference images corresponding to those face IDs and can be used to identify input user faces in cropped images that will be generated from subsequent video frames (e.g., of the same video recording).

At 1024, the face IDs are stored with the reference cropped images.

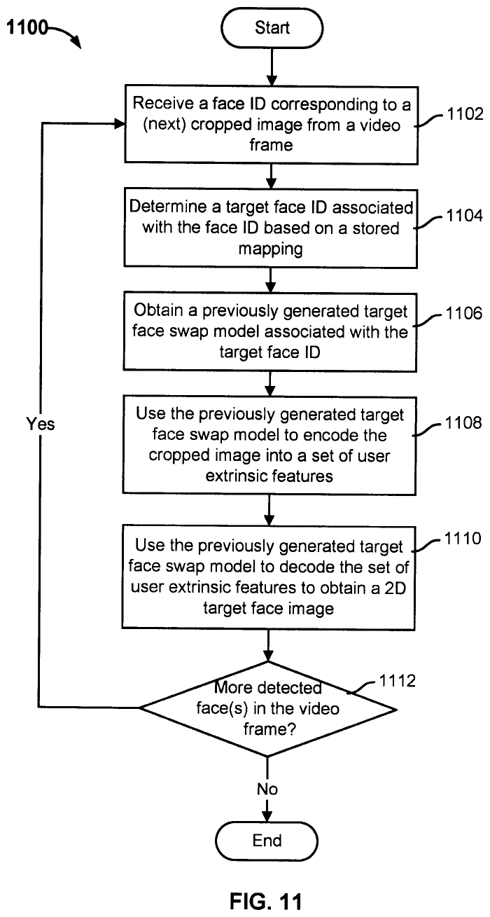

FIG. 11 is a flow diagram showing an example process for generating a 2D image of a target face corresponding to a detected input user face from a recorded video frame in accordance with some embodiments. In some embodiments, process 1100 is implemented at face augmentation server 108 of FIG. 1. In some embodiments, face swap inference 512 or 514 of pipeline 500 of FIG. 5 may be implemented using process 1100.

At 1102, a face ID corresponding to a (next) cropped image from a video frame is received. The face ID corresponding to the cropped image of each a detected input user face is determined using a process such as process 1000 of FIG. 10, for example.

At 1104, a target face ID associated with the face ID is determined based on a stored mapping. Mappings between face IDs of detected input user faces and target IDs are predetermined or submitted by the operator during the face swap pipeline.

At 1106, a previously generated target face swap model associated with the target face ID is obtained. The face swap model corresponding to each target face ID was previously generated and stored. In some embodiments, the face swap model corresponding to a particular target face was generated using cropped images that were generated with the same type of alignment that was used to obtain the cropped images of the input user faces that were detected from a video frame.

At 1108, the previously generated target face swap model is used to encode the cropped image into a set of user extrinsic features. The target face swap model encoder portion takes as input a cropped image of a detected input user face and then encodes the image into a set of vectors that represents extrinsic features of the input user face. In various embodiments, extrinsic features describe features of the input user face that are transferrable to another face. Examples of an extrinsic feature comprise an aspect of a facial expression or facial movement that is associated with a pixel pattern that is recognized by the target face swap model within the cropped image. For example, the set of user extrinsic features is a compact representation of the input user face in the cropped image and comprises 512 vectors.

At 1110, the previously generated target face swap model is used to decode the set of user extrinsic features to obtain a 2D target face image. The target face swap model comprises a mathematical representation of the target face that was generated based on cropped images of the target face. For example, a decoder of the target face model is a neural network with learned intrinsic facial features of the target face and renders the intrinsic facial features of the target face as indicated by the set of user extrinsic features (e.g., the set of 512 vectors). The resulting matrix forms a 2D image of the target face that shows the target face with extrinsic features that match those of the input user face as shown in the cropped image. In some embodiments, the output 2D image comprises red, green, blue (RGB) values along with alpha values for a target face mask. The mask describes the outline around the target face, excluding the hair, neck, and body of the target individual.

At 1112, whether there is at least one more detected input user face in the video frame is determined. In the event that there is at least one more detected input user face in the video frame, control is returned to 1102. Otherwise, in the event that there are no more detected input user faces in the video frame, process 1100 ends. While process 1100 suggests that a 2D target face image can be generated serially for each input user face, in actual implementation, 2D target face images can be generated at least in parallel for two or more input user faces based on their respective cropped images.

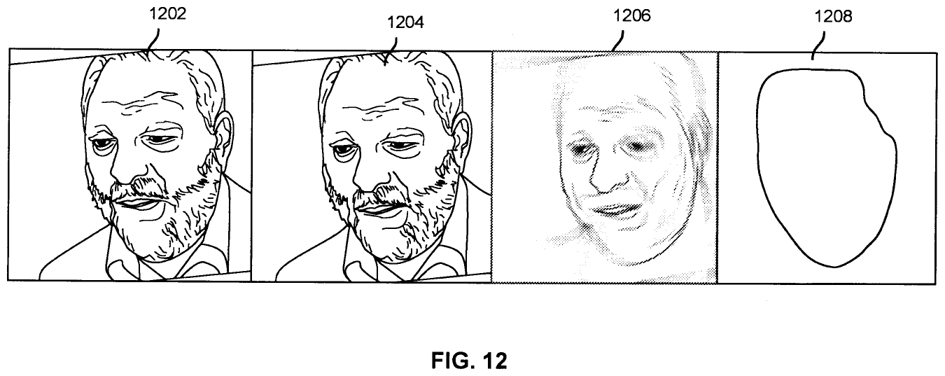

FIG. 12 is a diagram showing examples of a target face and an associated example mask associated with the target face. Cropped images 1202 and 1204 show the aligned target face and can be used to generate a target face swap model featuring the shown target face. Cropped image 1206 shows a version of the target face that blurs out the area of the image outside of the target face. Mask 1208 shows the mask of the target face that can be output by the target face swap model that shows only the area of the target face within a softened boundary of the target face.

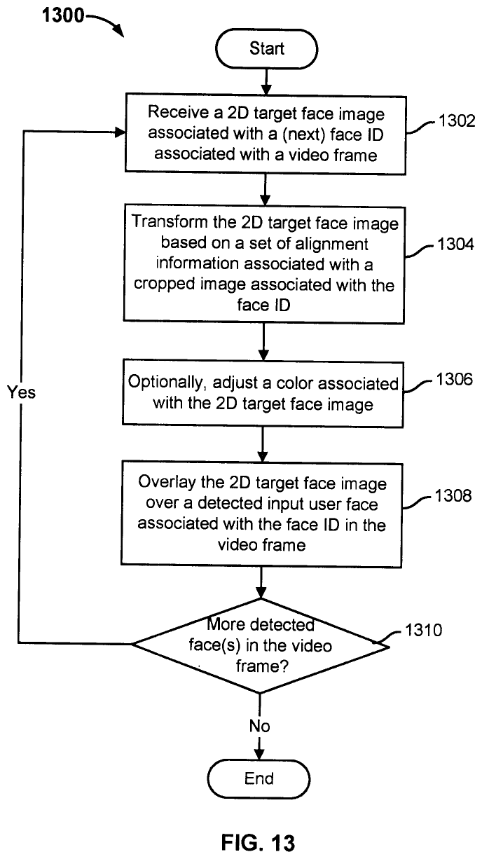

FIG. 13 is a flow diagram showing an example process for overlaying a 2D image of a target face over a detected input user face in a recorded video frame. In some embodiments, process 1300 is implemented at face augmentation server 108 of FIG. 1. In some embodiments, composite 516 of pipeline 500 of FIG. 5 may be implemented using process 1300.

At 1302, a 2D target face image associated with a (next) face ID associated with a video frame is received. In some embodiments, the 2D target face image associated with a face ID is generated using a process such as process 1100 of FIG. 11. The 2D target face image includes a mask that renders all but the target face in the image transparent.

At 1304, the 2D target face image is transformed based on a set of alignment information associated with a cropped image associated with the face ID. As described above, the cropped image of a detected input user face based on which the 2D target face image was generated was associated with a set of alignment information that described how the input user face in the original video frame was transformed to how it appears with the cropped image. The inverse of this same set of alignment information is then used to transform the 2D target face image to match the scale, rotation, and translation of the detected input user face as it appears in the video frame.

At 1306, a color associated with the 2D target face image is optionally adjusted. Optionally, the color associated with the 2D target face image (before or after it has been transformed using the set of alignment information) is adjusted to better match the ambient lighting in the video frame. For example, the color temperature of the video frame can be determined and then the 2D target face image can be adjusted to match the determined color temperature of the video frame.

At 1308, the 2D target face image is overlaid over a detected input user face associated with the face ID in the video frame. The transformed 2D target face image is then composited over the video frame at the location of the corresponding detected input user face. As described above, the 2D target face image includes only the target face with soft edges and therefore, the overlaid target face in the video frame will appear to have the same hair, neck, and body of the corresponding input user. As such, it will appear in the composited video frame that the input user has swapped faces with that of the target individual.

At 1310, whether there is at least one more detected input user face in the video frame is determined. In the event that there is at least one more detected input user face in the video frame, control is returned to 1302. Otherwise, in the event that there are no more detected input user faces in the video frame, process 1300 ends. While process 1300 suggests that a 2D target face image can be composited on the video frame serially for each input user face, in actual implementation, 2D target face images can be composited on the video frame at least in parallel for two or more input user faces.

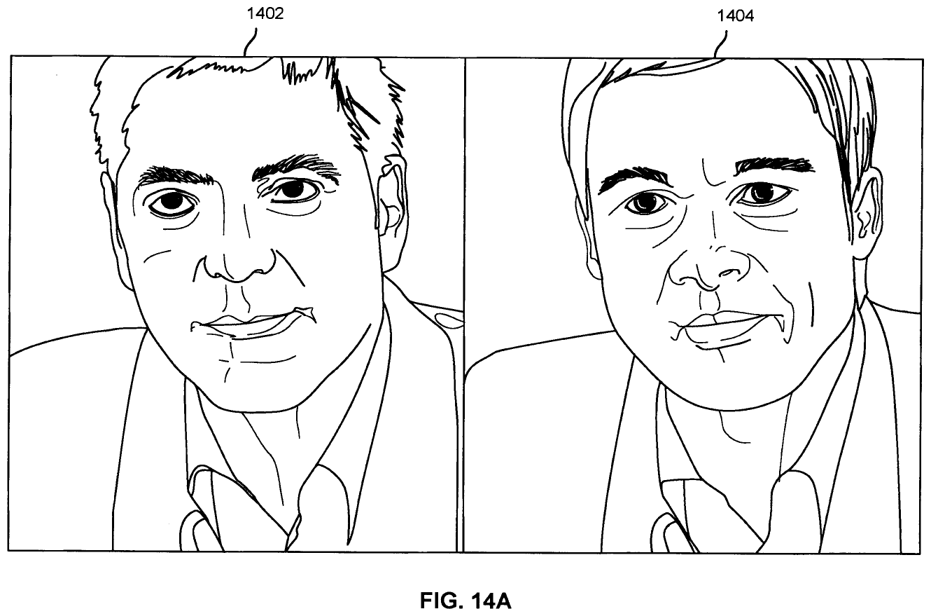

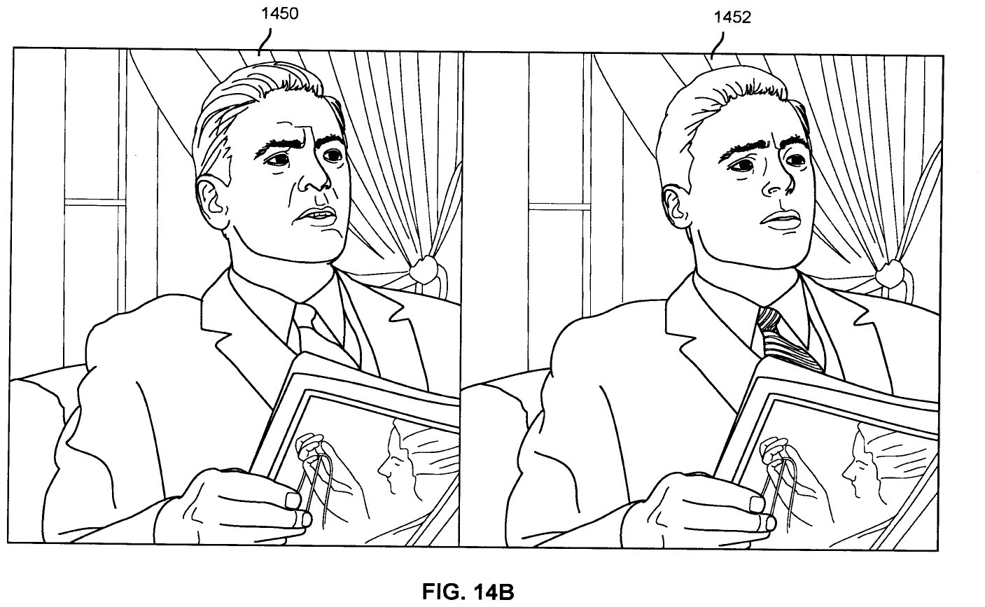

FIG. 14A is a diagram showing a first example of an original video frame and a corresponding composited video frame. Video frame 1402 is the original video frame that shows one input user face. After an application of a processing pipeline such as that described in pipeline 500 of FIG. 5 to recorded video frame 1402, a representation of a selected target face that is manipulated to inherit the extrinsic features of the input user face is generated and then overlaid onto video frame 1402 to result in composite video frame 1404, which shows the target face laid over the input user face but with matching extrinsic features (e.g., expressions) as the input user face.

FIG. 14B is a diagram showing a second example of an original video frame and a corresponding composited video frame. Video frame 1450 is the original video frame that shows one input user face. After an application of a processing pipeline such as that described in pipeline 500 of FIG. 5 to video frame 1450, a representation of a selected target face that is manipulated to inherit the extrinsic features of the input user face is generated and then overlaid onto video frame 1450 to result in composite video frame 1452, which shows the target face laid over the input user face but with matching extrinsic features (e.g., expressions) as the input user face. As shown in the example of FIG. 14B, composite video frame 1452 shows not only the target face laid over the input user face but shows the original input user's hair, neck, and body as well as the background of original video frame 1450.

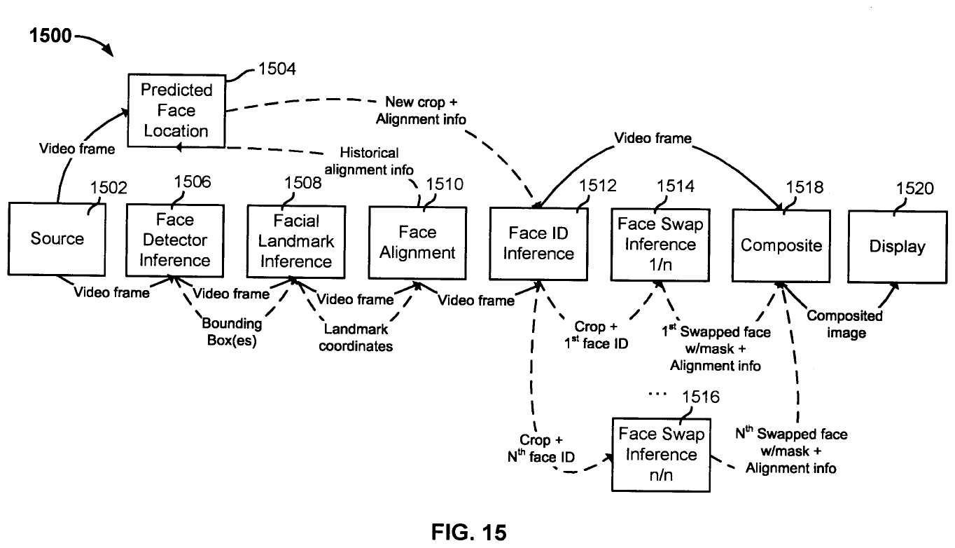

FIG. 15 is a diagram showing an example pipeline of using predicted face locations to generate a composite video frame with representation(s) of target face(s) corresponding to n input user faces that have been detected in an input recorded video frame. Predictive processing pipeline 1500 is a modified version of processing pipeline 500 of FIG. 500 in that predictive processing pipeline 1500 leverages the bounding boxes, facial landmarks, and alignment information corresponding to up to n input user faces obtained from one or more recent historical video frames from the same video recording to predict the updated locations of the facial features of the up to n input user faces in a current video frame and use these updated locations to generate a new cropped image of the input user face in the current video frame. As will be described below, by using historical input user face facial feature locations, a trajectory and/or rotation of each input user face can be predicted and then used to generate a cropped image of the input user face from the current video frame without waiting for the exact bounding box, facial landmarks, and alignment information corresponding to an input user face to be determined from the current video frame.

Source 1502 of face swap pipeline 1500 records a current video frame in the process of making a video recording. The source can be a camera or a storage at which a video frame is stored. For example, one or more input users are standing in front of and also facing the camera. The recorded video frame is output to both predicted face location 1504 and face detector inference 1506. Predicted face location 1504 is configured to receive the historical bounding boxes, facial landmarks, and/or alignment information associated with input user faces that were determined from up to a predetermined number (e.g., 10) of recent, historical video frames from the same video recording. Especially when source 1502 is operating on a faster clock and source 1502 is able to produce (e.g., high-definition/1080p) video frames at a high fps (e.g., 60 fps), the relative changes between input user face locations from one video frame to the next are not expected to be large. As such, predicted face location 1504 can use the historical bounding boxes, facial landmarks, and/or alignment information associated with input user faces detected from recent historical video frames associated with input user faces detected from recent historical video frames produced by source 1502 to accurately predict the new locations (e.g., bounding boxes, facial features, and/or alignments) of the input user faces in the current video frame without waiting for the actual locations to be determined. In some embodiments, predicted face location 1504 stores the historical bounding boxes, facial landmarks, and/or alignment information associated with input user faces detected from a predetermined number (e.g., 10) of most recent historical video frames and then uses this recent historical information to generate a cropped image of each detected input user face as well as a corresponding set of alignment information to output to face ID inference 1512 for further processing.

In parallel to predicted face location 1504 generating cropped images of input user faces from the current video frame, face detector inference 1506, facial landmark inference 1508, and face alignment 1510 are configured to respectively determine the bounding boxes, facial landmarks, and/or alignment information associated with input user faces detected within the current video frame similar to the operations of face detector inference 504, facial landmark inference 506, and face alignment 508 as described above for pipeline 500 of FIG. 5. In some embodiments, face detector inference 1506, facial landmark inference 1508, and face alignment 1510 can also output the bounding boxes, facial landmarks, and/or alignment information associated with input user faces detected within the current video frame to predicted face location 1504 for predicted face location 1504 to use as historical information to predict the input user faces' locations in the next video frame. In some embodiments, because face alignment 1510 generates cropped images of detected input user faces in parallel to predicted face location 1504 generating such cropped images, face alignment 1510 can send its cropped images based on actually detected input user face locations (and not predictions of input user face locations) so that predicated face location 1504 can use these actual cropped images to determine a discrepancy between the actual and predicted cropped images to determine whether an update to its prediction techniques (e.g., a machine learning model for predicting input user face locations) is needed. For example, if the discrepancy between the actual and predicted cropped images is greater than a predetermined threshold, the machine learning model for predicting input user face locations is retrained to adjust the weights of the model. Face ID inference 1512, face swap inference 1/n 1514, face swap inference n/n 1516, composite 1518, and display 1520 are respectively configured to operate similarly to face ID inference 510, face swap inference 1/n 512, face swap inference n/n 514, composite 516, and display 518 as described for pipeline 500 of FIG. 5. Taken altogether, so long as historical input user face location information from recent video frames is available, predictive processing pipeline 1500 provides faster outputs of composited video frames (as therefore, lower glass-to-glass latency) than process 500 due to the predictions that can be made based on such historical location information.

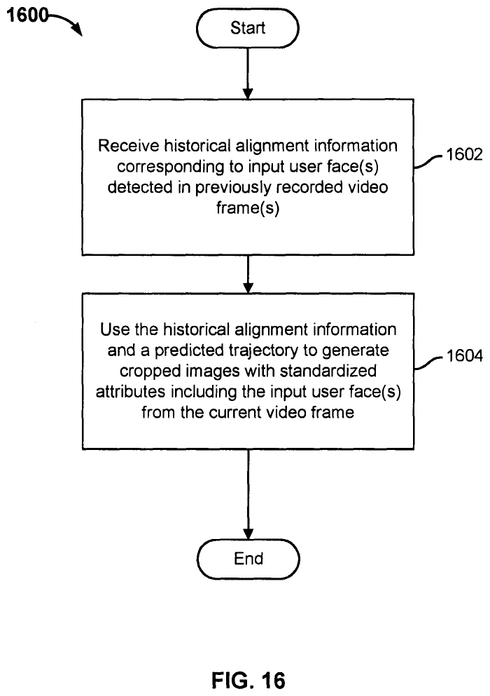

FIG. 16 is a flow diagram showing an example process of using predicted face locations to generate cropped images of input user faces from a current video frame in accordance with some embodiments. In some embodiments, process 1600 is implemented at face augmentation server 108 of FIG. 1. In some embodiments, predicted face location 1504 of pipeline 1500 of FIG. 15 may be implemented using process 1600.

At 1602, historical alignment information corresponding to input user face(s) detected in previously recorded video frame(s) is received. In some embodiments, the bounding boxes, facial landmarks, and/or alignment information of input user faces that were detected in a predetermined number of most recent video frames relative to a current video frame of the same video recording are retrieved from storage (e.g., memory).

At 1604, the historical alignment information and a predicted trajectory are used to generate cropped images with standardized attributes including the input user face(s) from a current video frame. Such historical bounding boxes, facial landmarks, and/or alignment information of input user faces that were detected in the predetermined number of most recent video frames are used to determine a predicted trajectory of each of one or more input user faces and these trajectories are used to predict the current location(s) (e.g., of the user's heads, of the user's facial features) within the current video frame. The predicted locations are then used to align, orient, and/or scale each input user face in the current video frame to standard locations within a crop of the current video frame and as such, cropped images are generated of the input user faces from the current video frame and are to be used for further processing in the face swap pipeline.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a memory; and
a processor coupled to the memory and configured to:
obtain a set of user facial features corresponding to an input user face in a recorded video frame;
use at least the recorded video frame and the set of user facial features to generate a cropped image comprising the input user face;
use a target face swap model to encode at least a portion of the cropped image into a plurality of user extrinsic features;
use the target face swap model and the plurality of user extrinsic features to generate a representation of a target face; and
overlay the representation of the target face over the recorded video frame.

2. The system of claim 1, wherein the processor is further configured to:
receive the recorded video frame;
receive a specified number of input user faces to detect; and
detect one or more input user faces within the recorded video frame according to the specified number.

3. The system of claim 1, wherein the processor is further configured to determine a face identifier (ID) associated with the input user face.

4. The system of claim 3, wherein the processor is further configured to:
determine a target face ID that maps to the face ID associated with the input user face; and
obtain, from storage, the target face swap model associated with the target face ID.

5. The system of claim 1, wherein the target face swap model was previously generated using images of the target face, wherein the images of the target face comprise cropped images that were aligned according to standardized parameters.

6. The system of claim 5, wherein the cropped image comprising the input user face was also aligned according to the standardized parameters.

7. The system of claim 1, wherein the representation of the target face comprises a 2-dimensional (2D) image of the target face.

8. The system of claim 7, wherein the 2D image of the target face comprises an RGB image with a mask.

9. The system of claim 1, wherein the processor is further configured to generate a set of alignment information associated with the input user face, wherein the set of alignment information describes one or more of the following: a scale of the input user face, a rotation of the input user face, and a translation of the input user face in the cropped image relative to the recorded video frame.

10. The system of claim 9, wherein the processor is further configured to modify the representation of the target face using the alignment information prior to overlaying the representation of the target face over the recorded video frame.

11. The system of claim 10, wherein the processor is further configured to output the recorded video frame with the overlay of the representation of the target face at a display.

12. The system of claim 1, wherein the recorded video frame comprises a first recorded video frame, wherein the cropped image comprises a first cropped image, and wherein the processor is further configured to:
obtain a second recorded video frame; and
use at least the second recorded video frame and the set of user facial features associated with the input user face in the first recorded video frame to predict a second cropped image comprising the input user face.

13. The system of claim 12, wherein the plurality of user extrinsic features comprises a first plurality of user extrinsic features, wherein the representation of the target face comprises a first representation of the target face, and wherein the processor is further configured to:
use the target face swap model to encode at least a portion of the second cropped image into a second plurality of user extrinsic features;
use the target face swap model and the second plurality of user extrinsic features to generate a second representation of the target face; and
overlay the second representation of the target face over the second recorded video frame.

14. A method, comprising:
obtaining a set of user facial features corresponding to an input user face in a recorded video frame;
using at least the recorded video frame and the set of user facial features to generate a cropped image comprising the input user face;
using a target face swap model to encode at least a portion of the cropped image into a plurality of user extrinsic features;
using the target face swap model and the plurality of user extrinsic features to generate a representation of a target face; and
overlaying the representation of the target face over the recorded video frame.

15. The method of claim 14, further comprising:
receiving the recorded video frame;
receiving a specified number of input user faces to detect; and
detecting one or more input user faces within the recorded video frame according to the specified number.

16. The method of claim 14, further comprising determining a face identifier (ID) associated with the input user face.

17. The method of claim 16, further comprising:
determining a target face ID that maps to the face ID associated with the input user face; and
obtaining, from storage, the target face swap model associated with the target face ID.

18. The method of claim 14, further comprising generating a set of alignment information associated with the input user face, wherein the set of alignment information describes one or more of the following: a scale of the input user face, a rotation of the input user face, and a translation of the input user face in the cropped image relative to the recorded video frame.

19. The method of claim 14, wherein the recorded video frame comprises a first recorded video frame, wherein the cropped image comprises a first cropped image, and further comprising:
obtaining a second recorded video frame; and
using at least the second recorded video frame and the set of user facial features associated with the input user face in the first recorded video frame to predict a second cropped image comprising the input user face.

20. A computer program product, the computer program product being embodied in a non-transitory computer readable storage medium and comprising computer instructions for:
obtaining a set of user facial features corresponding to an input user face in a recorded video frame;
using at least the recorded video frame and the set of user facial features to generate a cropped image comprising the input user face;
using a target face swap model to encode at least a portion of the cropped image into a plurality of user extrinsic features;
using the target face swap model and the plurality of user extrinsic features to generate a representation of a target face; and
overlaying the representation of the target face over the recorded video frame.
